(19) United States
(12) Patent Application Publication
(10) Pub. No.: US 2014/0352879 A1
(43) Pub. Date: Dec. 4, 2014

(54) TECHNIQUES FOR FABRICATING AN ACTUATOR ELEMENT

(71) Applicant: Bayer MaterialScience AG, Leverkusen (DE)

(72) Inventors: Mikyong Yoo, Palo Alto, CA (US); Xina Quan, Saratoga, CA (US)

(21) Appl. No.: 14/363,504

(22) PCT Filed: Jan. 14, 2013
(86) PCT No.: PCT/US12/68342

§ 371 Date: Jun. 6, 2014

Related U.S. Application Data
(60) Provisional application No. 61/568,753, filed on Dec. 9, 2011.

(51) Int. Cl. H02N 2/00

(52) U.S. Cl. CPC H02N 2/22
USPC 156/220; 156/229; 156/273.7; 156/60

(57) ABSTRACT

A process of fabricating an actuator element is provided. In the process, a dielectric elastomer film having first and second sides is provided. An electrode material is applied on a portion of the first and second side of the dielectric elastomer film. A compressive material is applied to the first side of the dielectric elastomer film. The present process may be employed for producing improved monolithic actuator elements such as configurable buttons, arrays of buttons, and the like.

### CROSS REFERENCE TO RELATED APPLICATION

This application claims the benefit, under 35 USC §119(e), of U.S. provisional patent application No. 61/568,753, filed Dec. 9, 2011, entitled “Z-MODE FOR SURFACE MORPHING”; the entire disclosure of which is hereby incorporated by reference.

### FIELD OF THE INVENTION

In various embodiments, the present disclosure relates generally to methods of processing thin film electroactive polymer, electrodes, adhesive, and foam to fabricate haptic actuator structures. More specifically, the present process is employed for producing monolithic actuator elements such as configurable buttons, arrays of buttons, and the like.

### BACKGROUND OF THE INVENTION

Electroactive polymer artificial muscle (EPAM) can be processed into various actuator elements that are responsive to touch, provide haptic feedback, and are generally compact in size. These actuator elements may find use in a variety of applications, and are not limited to haptic feedback. In the most general form, such EPAM actuator elements comprise a thin sheet, which comprises a dielectric elastomer film sandwiched between two electrode layers. When a high voltage is applied to the electrodes, the two attracting electrodes compress the film thickness in the energized area. The EPAM actuator elements provide a slim, low-powered actuator module that can be placed underneath an inertial mass (usually a battery or a touch surface) on a movable suspension to generate haptic feedback that can be perceived by the user. The present disclosure provides various embodiments of methods for fabricating such actuator elements.

### SUMMARY OF THE INVENTION

In one embodiment, a dielectric elastomer film is provided. An electrode pattern is deposited on both sides of the film. An adhesive pattern is applied on at least one side of the film. A compressive material is applied onto the adhesive. A rigid substrate is applied to the compressive material and pressure is applied to contact the substrate with the adhesive pattern. In various embodiments, the compressive material may be a foam material, a gel material or a molded structure. In one embodiment, the foam structure has a predetermined embossed pattern. In another embodiment, the foam structure is a flat sheet. The foam sheet is locally heated or photo exposed in a predetermined pattern to collapse or degrade the foam in a corresponding pattern. In yet another embodiment, the foam sheet is formed by locally heating or photo exposing a predetermined pattern to expand the foam in a corresponding pattern. In still another embodiment, key caps may be adhered to the multilayer structure to provide a more robust user surface.

The present process may be employed for producing improved monolithic actuator elements such as configurable buttons, arrays of buttons, and the like.

### BRIEF DESCRIPTION OF THE FIGURES

The present invention will now be described for purposes of illustration and not limitation in conjunction with the figures, wherein:

FIGS. 1A and 1B illustrate one embodiment of an actuator element that can be fabricated in accordance with various embodiments of the present method;

FIG. 2 is one embodiment of an array of actuator elements as shown in FIGS. 1A, 1B that can be fabricated in accordance with various embodiments of the present method;

FIG. 3 is a top view of one embodiment of an actuator element comprising an adhesive provided on a substrate and multiple columns or elements of compressive material provided on the substrate arranged in a matrix or lattice;

FIG. 4 illustrates one embodiment of a technique for applying an adhesive on a substrate;

FIG. 5 is a cross-sectional view of one embodiment of the actuator element of FIG. 3;

FIG. 6 illustrates a compressed compressive material such that the proximal sides of the electrodes contact the adhesive;

FIG. 7 illustrates an actuator element subassembly comprising a compressive material in the form of a sheet, a substrate, and a dielectric elastomer film with electrodes formed on either side of the film stacked and laminated onto the compressive material;

FIG. 8 illustrates one embodiment of a process for fabricating an actuator element using localized heating of the substrate to collapse or degrade the compressive material in the heated areas;

FIG. 9 illustrates one embodiment of a process for fabricating an actuator element using localized photo exposure of the substrate to collapse or degrade the compressive material;

FIG. 10 illustrates an actuator element subassembly comprising a compressive material that is in a compressed state in the form of a solid film;

FIG. 11 illustrates one embodiment of a process for fabricating an actuator element using localized heating of a substrate to expand a compressive material in the heated areas;

FIG. 12 illustrates one embodiment of a process for fabricating an actuator element using localized photo exposure of a substrate to expand or decompress the compressive material;

FIG. 13 illustrates one embodiment of a roll-to-roll process for fabricating an actuator element;

FIG. 14 illustrates one embodiment of a roll-to-roll process for fabricating an actuator element;

FIG. 15 illustrates one embodiment of a roll-to-roll process for fabricating an actuator element; and

FIG. 16 illustrates one embodiment of an actuator element comprising key caps.

### DETAILED DESCRIPTION OF THE INVENTION

Before explaining the disclosed embodiments in detail, it should be noted that the disclosed embodiments are not limited in application or use to the details of construction and arrangement of parts illustrated in the accompanying drawings and description. The disclosed embodiments may be implemented or incorporated in other embodiments, variations and modifications, and may be practiced or carried out in various ways. Further, unless otherwise indicated, the terms and expressions employed herein have been chosen for the purpose of describing the illustrative embodiments for the convenience of the reader and are not for the purpose of limitation thereof. Further, it should be understood that any one or more of the disclosed embodiments, expressions of embodiments, and examples can be combined with any one or more of the other disclosed embodiments, expressions of embodiments, and examples, without limitation. Thus, the combination of an element disclosed in one embodiment and an element disclosed in another embodiment is considered to be within the scope of the present disclosure and appended claims.

The present disclosure provides various embodiments of processes for processing thin film electroactive polymer, electrodes, adhesive, and foam to fabricate haptic structures. More specifically, the present process is employed for making monolithic actuator elements such as configurable buttons, arrays of buttons, and the like.

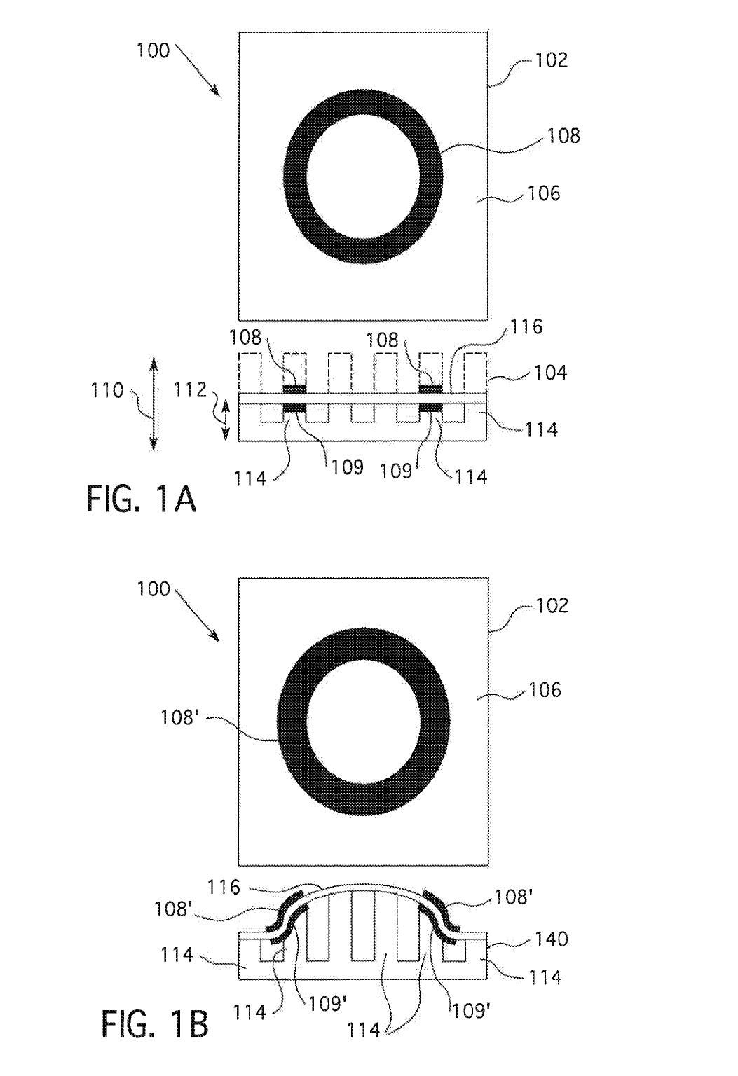

Before launching into a description of various methods of fabricating actuator elements, the present disclosure briefly turns to FIGS. 1A and 1B, which illustrate one embodiment of an actuator element 100 fabricated in accordance with various embodiments of the present process. In one embodiment, the actuator element 100 is a button. In another embodiment, the actuator element 100 is a display element. FIG. 1A is a top view 102 and a side view 104 of the actuator element 100 in an unpowered state. FIG. 1B is a top view 102 and a side view 140 of the actuator element 100 in a powered state. The configurable button actuator 100 comprises top and bottom electrodes 108, 109 supported by a dielectric elastomer film 106 and a plurality of expandable foam (or gel) structures 114. In a passive state, when the electrodes 108, 109 are unpowered, the height 112 of the expandable foam (or gel) structures 114 is highly compressed by the stretched dielectric elastomer film 106, e.g., from a height of about 2 mm down to about 1 mm. The total device height can be about 1 mm small. In an active state, when the electrodes 108′, 109′ are powered, the height 110 of the expandable foam (or gel) structures 114′ returns to its original height. In an active state, the regions of powered electrodes 108′, 109′ expand and effectively have a lower modulus. No longer being constrained, the expandable foam (or gel) structures 114′ are free to expand to their original height 110. The active regions where the electrodes 108′, 109′ are powered are effectively softer and can stretch to accommodate expansion of the expandable foam structures 114′. In the region above the expanding expandable foam structures 114′, the dielectric elastomer film 116 is raised. The area showing a raised portion where the expandable foam structures 114′ push up against the dielectric elastomer film 116 can be used as an indicator when an electric field is applied to the electrodes 108′, 109′.

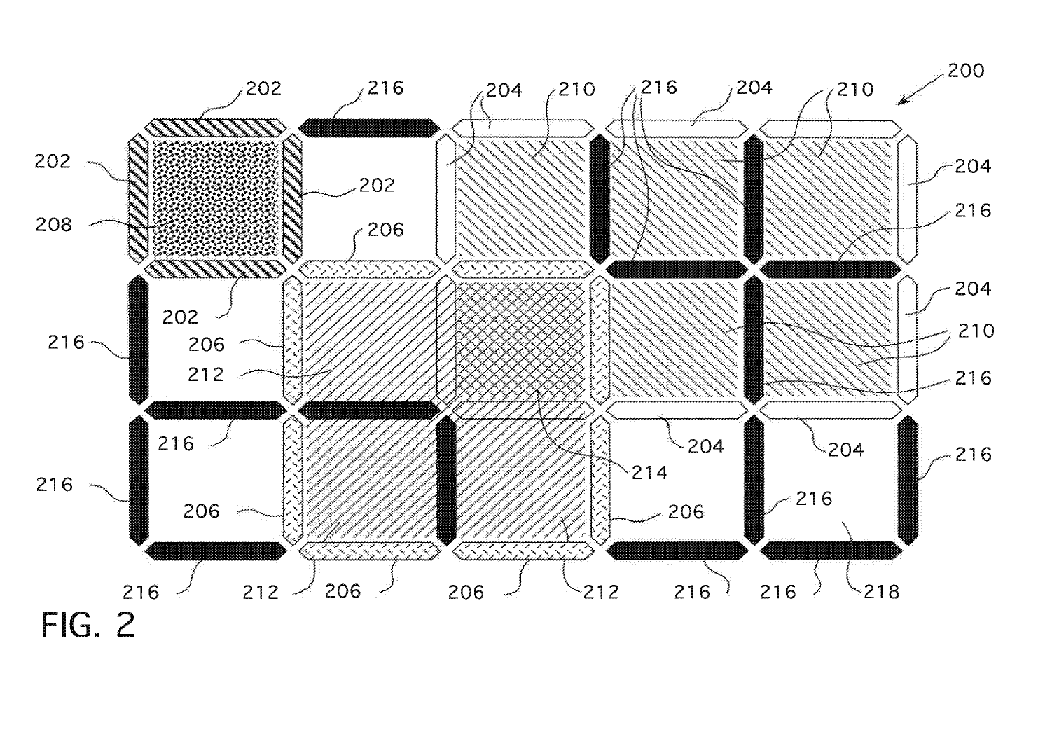

FIG. 2 is one embodiment of a matrix of configurable features 200 fabricated using the actuator element shown in FIGS. 1A, 1B, that can be fabricated in accordance with various embodiments of the present method. As shown in FIG. 2, the matrix of configurable features 200 comprises a plurality of electrode segments. Controllers can be configured to drive the matrix of configurable features 200 to address specific segments to expand the energized region. The segments can be energized in any suitable configuration. For example, a first set of segments 202 are energized to define a first raised feature 208. A second set of segments 204 are energized to define a second raised feature 210. A third set of segments 206 are energized to define a third raised feature 212. A fourth raised feature 214 can be formed when the energized regions overlap. Unenergized segments 216 do not expand the corresponding regions 218. It will be appreciated that the various segments of the matrix of configurable features 200 can be energized in any suitable manner to accomplish a desired configuration of raised features. The raised features can have arbitrary size, shape, and location. With different energizing voltages, features can be raised to different heights.

The actuator elements shown in FIGS. 1A, 1B, and 2 can be fabricated using any embodiments of the processes described herein. In various aspects, such actuator elements may comprise multiple small columns per “button” to enable more versatility in the configuration and also to be less visible. Gel columns or hollow cylinders may be used as well, provided the gel materials are selected to deform or bow out under compressive strain without compressive set or fracture. The gel materials should preferably be resilient and able to return to an un-deformed state after removal of the compressive strain. Optically clear devices may be fabricated using gel columns rather than foam structures, for example. Expandable structures can also include molded constructions such as arrays of bellows, flexures, springs, or oblate or hyperboloid structures. Vacuum bagging or lamination may be used to prepare the composites.

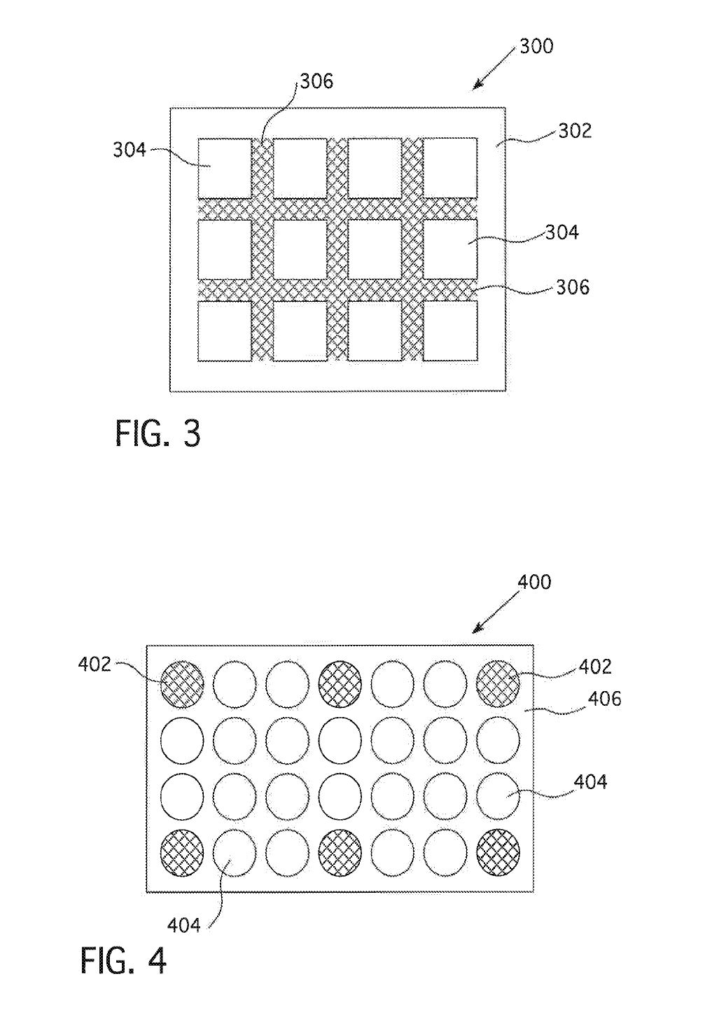

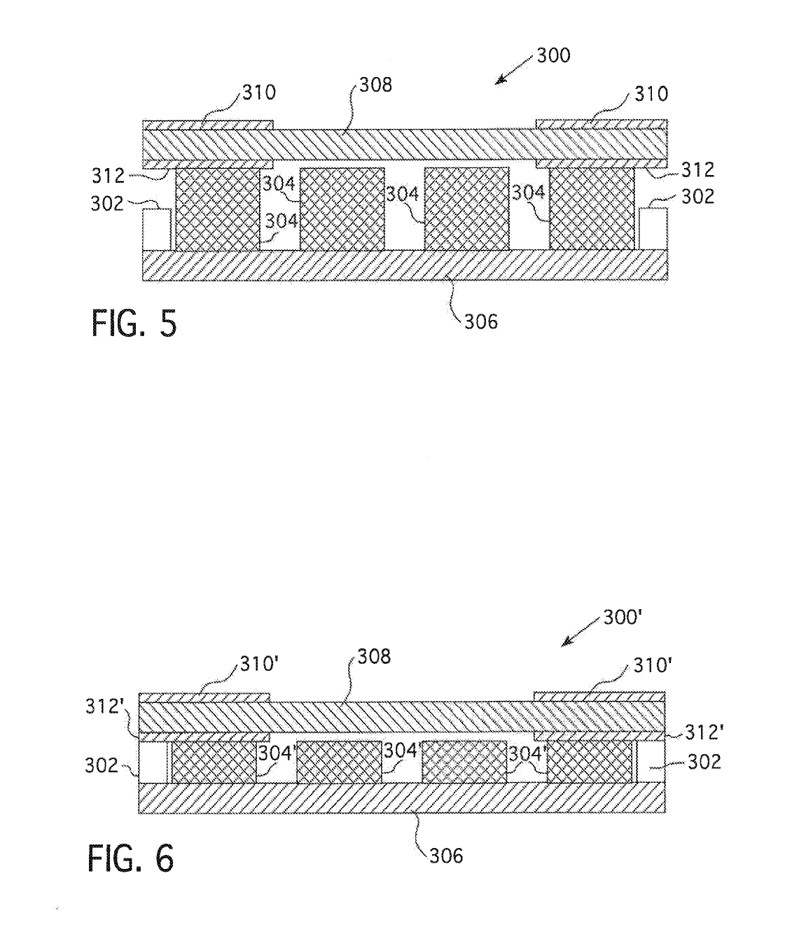

The present disclosure now turns to a description of several processes that may be employed to fabricate the actuator elements illustrated in FIGS. 1A, 1B, and 2 and similar structures. Accordingly, reference is now made to FIGS. 3-6, where processes for combining adhesives and compressive materials with dielectric elastomer films to make monolithic actuator elements are disclosed. As used herein a compressive material is any material that can be compressed in response to an applied force and expands or decompresses when the force is removed. FIG. 3 is a top view of one embodiment of an actuator element 300 comprising an adhesive 302 provided on a substrate 306 and multiple columns or elements of compressive material 304 provided on the substrate 306 arranged in a matrix or lattice. For clarity of disclosure, the actuator element 300 shown in FIG. 3 does not contain a dielectric elastomer film and electrodes. Cross-sectional views of the actuator element 300 including the dielectric elastomer film and electrodes are provided in FIGS. 5 and 6. Referring to FIG. 3, the space between the compressive material elements 304 is where the electrodes would be located. In one embodiment, the compressive material elements 304 may be made of foam and in another embodiment, the compressive material elements 304 may be made of gel. Both foam and gel have advantages. For example, foam has more lateral stability than gel whereas gel may be formed with optically transparent properties.

The adhesive 302 and the compressive material elements 304 may be applied to the substrate in various patterns. As shown in FIG. 3, the adhesive 302 is applied about the perimeter of the substrate 306 and the compressive material elements 304 are formed is a quadrilateral shaped column, e.g., square columns. FIG. 4 illustrates one embodiment of a technique for applying an adhesive 402 on a substrate 406. As shown in FIG. 4, compressive material elements 404 are arranged in a lattice or matrix of multiple cylindrical column elements. The adhesive 402 is arranged in multiple cylindrical column elements. Also, for clarity of disclosure, the actuator element 400 shown in FIG. 4 does not contain a dielectric elastomer film or electrodes.

Turning now to FIG. 5, in one embodiment, the actuator element 300 of FIG. 3 is shown in cross-sectional view. As shown in FIG. 5, the actuator element 300 is fabricated with the compressive material 304 in an expanded state. Initially, the adhesive 302 is applied to the substrate 306. The compressive material 304 is then laminated onto the substrate 306 in an expanded form. Electrodes 310, 312 are deposited on either side of a dielectric elastomer film 308. The dielectric elastomer film 308 with the deposited electrodes 310, 312 is then applied to the compressive material 304.

Turning to FIG. 6, once the module shown in FIG. 5 is assembled, the compressive material 304′ is compressed, such that the proximal sides of the electrodes 312 contact the adhesive 302. Compression can be accomplished using a variety of techniques, which are described hereinbelow. As shown in FIG. 6, the compressed assembly 300′ is now ready to be incorporated into a haptic device or display. In operation, the actuator element 300 works in a manner similar to that described with respect to FIGS. 1A, 1B where in a passive state, when the electrodes 310, 312 are unpowered the actuator element 300 is highly compressed by the stretched dielectric elastomer film 308, as shown in FIG. 6. The compressed dimension in the vertical axis may range, e.g., from a height of about 2 mm down to about 1 mm. The total device height can be about 1 mm small. In an active state, when the electrodes 310′, 312′ are powered, the height of the expandable foam (or gel) compressive materials 304′ returns to its original height, as shown in FIG. 5. In an active state, the regions of powered electrodes 310′, 312′ expand and effectively have a lower modulus. No longer being constrained, the expandable compressive materials 304′ are free to expand to their original uncompressed height. The active regions where the electrodes 310′, 312′ are powered are effectively softer and can stretch to accommodate expansion of the expandable compressive materials 304′. In the region above the expanding expandable compressive materials 304′, the dielectric elastomer film 308 expands. The resulting raised portion where the expandable foam structures 304′ push up against the dielectric elastomer film 308 can be used as an indicator when an electric field is applied to the electrodes 310′, 312′.

With reference now to FIGS. 3, 5, and 6, during the manufacturing process the compressive materials 304, 404 (e.g., foam or gel, or other suitable material) can be expanded first and then compressed (or deformed in the case of a gel) during a lamination step. Alternatively, the assembly could be laminated together first and then the compressed compressive material 304, 404 can be expanded afterwards. The adhesive 302, 402 can be either pressure sensitive or cured during or after lamination. Lamination may be done in a roll laminator or by vacuum-bagging the entire assembly to compress the compressive material 304, 404 and pull the components together. In some cases, it may be advantageous to position the adhesive 302, 402 away from the electrodes. For configuration flexibility, the adhesive 302, 402 features may be more sparsely distributed than the compressive material elements 304, 404, as shown in FIG. 4, for example.

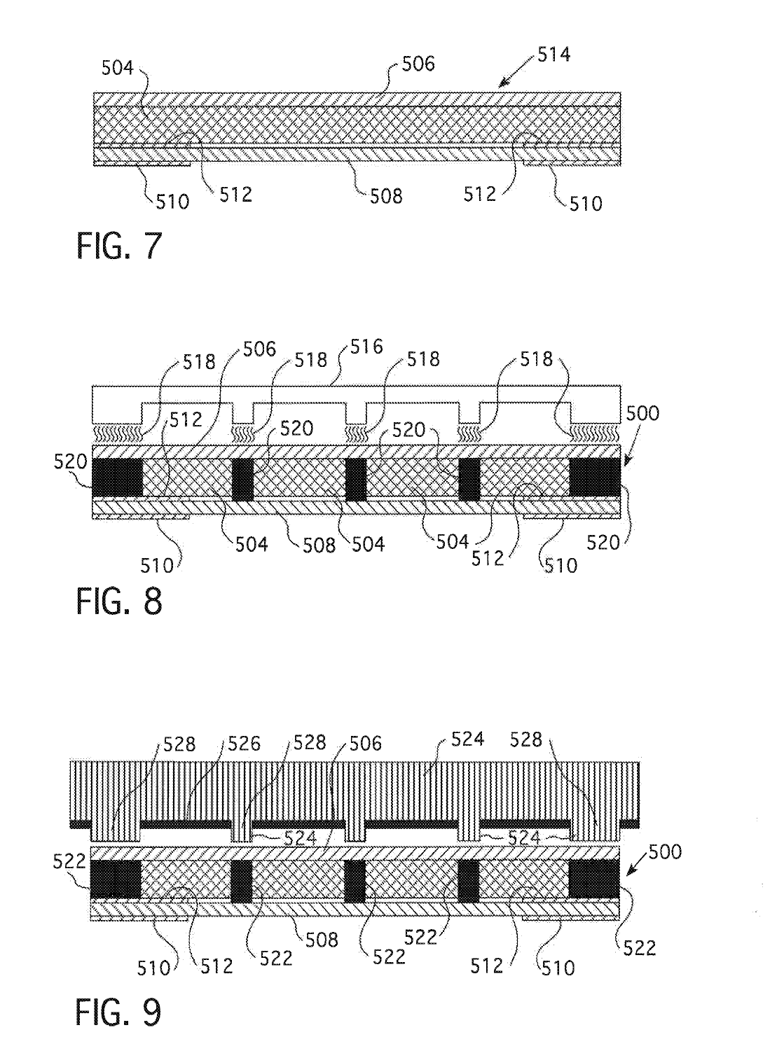

FIGS. 7-9 illustrate various embodiments of processes for making an actuator element 500 as shown in FIGS. 8 and 9. This provides an alternative process to expanding the compressive material against a template or printing process. The alternative process can be carried out with a laminated or stacked compressive material 504 in the form of a sheet and one or more substrates 506. With reference now to FIG. 7, an actuator element subassembly 514 comprises a compressive material 504 in the form of a sheet, a substrate 506, and a dielectric elastomer film 508 with electrodes 510, 512 formed on either side of the film 508 stacked and laminated onto the compressive material 504. Once the lamination process is complete, the compressive material 504 is compressed using suitable techniques such as localized heating, photo exposure, and the like.

FIG. 8 illustrates one embodiment of a process for fabricating an actuator element 500 using localized heating of the substrate 506 to collapse or degrade the compressive material 504 in the heated areas. Prior to compression, however, the actuator element subassembly 514 will undergo additional processing to form the actuator element 500. As shown in FIG. 8, for example, in one embodiment the process of fabricating the actuator element 500 comprises exposing the actuator element subassembly 514 to a radiant heating element 516 to locally heat 518 the substrate 506 side of the actuator element subassembly 514. In one embodiment, the radiant heating element 516 comprises an infrared (IR) source. The localized heat 518 collapses or degrades the compressive material 504 (e.g., foam or gel). The collapsed areas 520 may form an adhesive bond. Low heat 518 applied to the substrate 506 may expand the substrate 506 sufficiently to offset deformation from shrinkage due to condensing the compressive material 504 and improve planarity of the device surface.

FIG. 9 illustrates one embodiment of a process for fabricating an actuator element 500 using localized photo exposure of the substrate 506 to collapse or degrade the compressive material 504. As shown in FIG. 9, for example, in one embodiment the process of fabricating the actuator element 500 comprises photo exposing the actuator element subassembly 514 to a light source through a mask 526 comprising apertures 528 for transmitting light 524 from the light source. In one embodiment, the light 524 is ultraviolet (UV) light. The light locally exposes the substrate 506 side of the actuator element subassembly 514. The localized photo exposure 518 collapses or degrades the compressive material 504 (e.g., foam or gel). The collapsed areas 522 may form an adhesive bond.

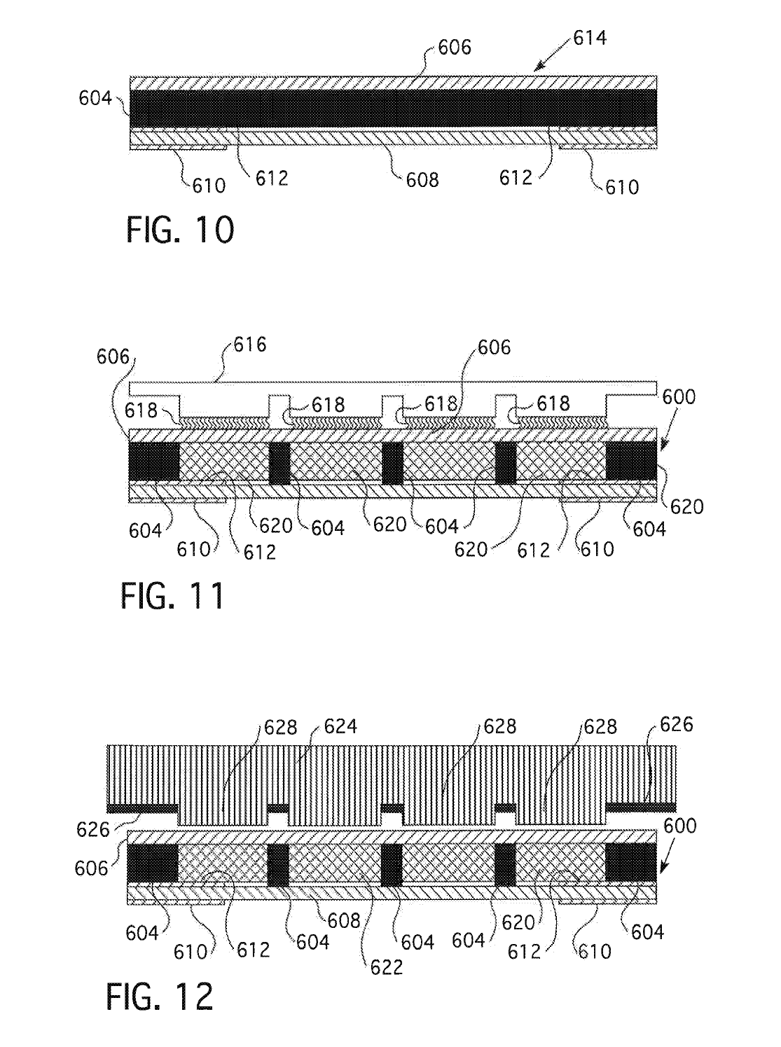

FIGS. 10-12 illustrate various embodiments of processes for making an actuator element 600 as shown in FIGS. 11 and 12. This provides an alternative process to expanding the compressive material against a template or printing process. The alternative process can be carried out with a stacked or laminated solid film material and a substrate 606. In one embodiment, the solid film material may be an adhesive. With reference now to FIG. 10, an actuator element subassembly 614 comprises a compressive material 604 that is in a compressed state in the form of a solid film, for example. A substrate 606 and a dielectric elastomer film 608 with electrodes 610, 612 are formed on either side of the film 608 stacked and laminated onto the compressed compressive material 604. Once the lamination process is complete, the compressed compressive material 604 is expanded or decompressed using suitable techniques such as localized heating, photo exposure, and the like.

FIG. 11 illustrates one embodiment of a process for fabricating an actuator element 600 using localized heating of the substrate 606 to expand the compressive material 604 in the heated areas. Prior to decompression (expansion), however, the actuator element subassembly 614 will undergo additional processing to form the actuator element 600. As shown in FIG. 11, for example, in one embodiment the process of fabricating the actuator element 600 comprises exposing the actuator element subassembly 614 to a radiant heating element 616 to locally heat 618 the substrate 606 side of the actuator element subassembly 614. In one embodiment, the radiant heating element 516 comprises an infrared (IR) source. The localized heat 618 expands or decompresses the compressed compressive material 604 (e.g., foam or gel). Low heat 618 applied to the substrate 606 may expand the substrate 606 sufficiently to offset deformation from shrinkage due to condensing the compressive material 604 and improve planarity of the device surface. Heating 618 the substrate 606 can also soften it enough to allow additional expansion of the compressive material 604. Subsequently cooling the substrate 606 would then compress the compressive material 604.

FIG. 12 illustrates one embodiment of a process for fabricating an actuator element 600 using localized photo exposure of the substrate 606 to expand or decompress the compressive material 604. As shown in FIG. 12, for example, in one embodiment the process of fabricating the actuator element 600 comprises photo exposing the actuator element subassembly 614 to a light source through a mask 626 comprising apertures 628 for transmitting light 624 from the light source. In one embodiment, the light 624 is ultraviolet (UV) light. The light locally exposes the substrate 606 side of the actuator element subassembly 614. The localized photo exposure 618 expands or decompresses the compressive material 604 (e.g., foam or gel).

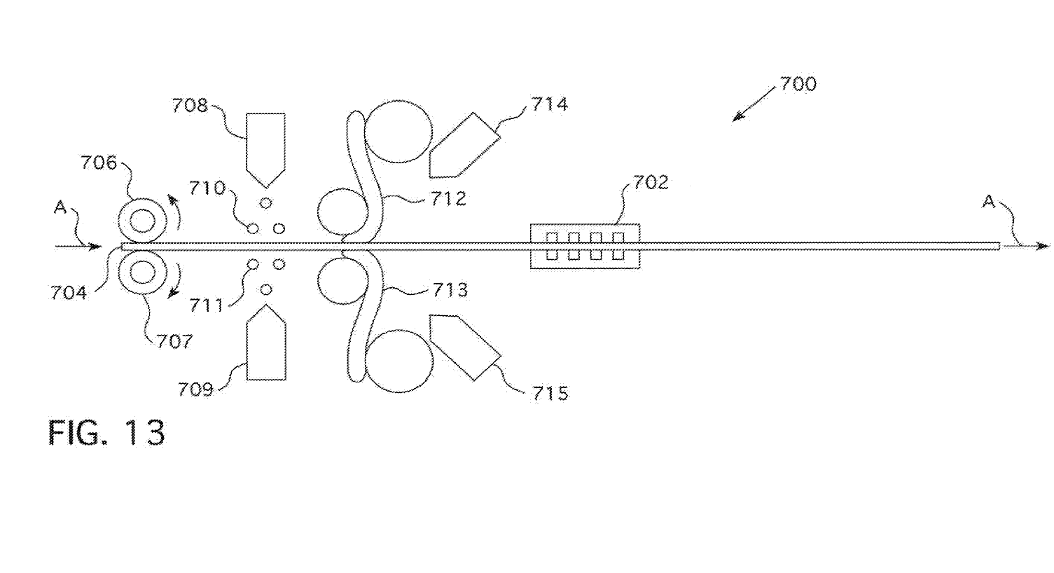

FIG. 13 illustrates one embodiment of a roll-to-roll process 700 for fabricating an actuator element 702 according to the present disclosure. The process 700 moves from left-to-right in the direction of arrow A. A dielectric elastomer film 704 is introduced into a first pair of rolls 706, 707 and is advanced to an electrode deposition station where electrode material 710, 711 is deposited on both sides of the strained dielectric elastomer film 704 by electrode deposition elements 708, 709 in a predetermined pattern. The dielectric film 704 can be used as-is or it can pre-strained (pre-stretched) in one dimension. Next, a compressive material 712, 714 (e.g., encapsulant) is laminated onto the dielectric elastomer film 704 with the electrodes deposited thereon. Alternatively, the compressive material 712, 713 can be applied by direct casting onto the dielectric elastomer film 704 with the electrodes deposited thereon. At the next step, either heat (e.g., IR) or light (e.g., UV) is applied to the encapsulated subassembly to collapse/degrade or expand the compressive material 712, 713, as discussed in connection with FIGS. 7-12, for example. Next, an output bar is applied and the subassembly is cut in a die to produce the actuator element 702.

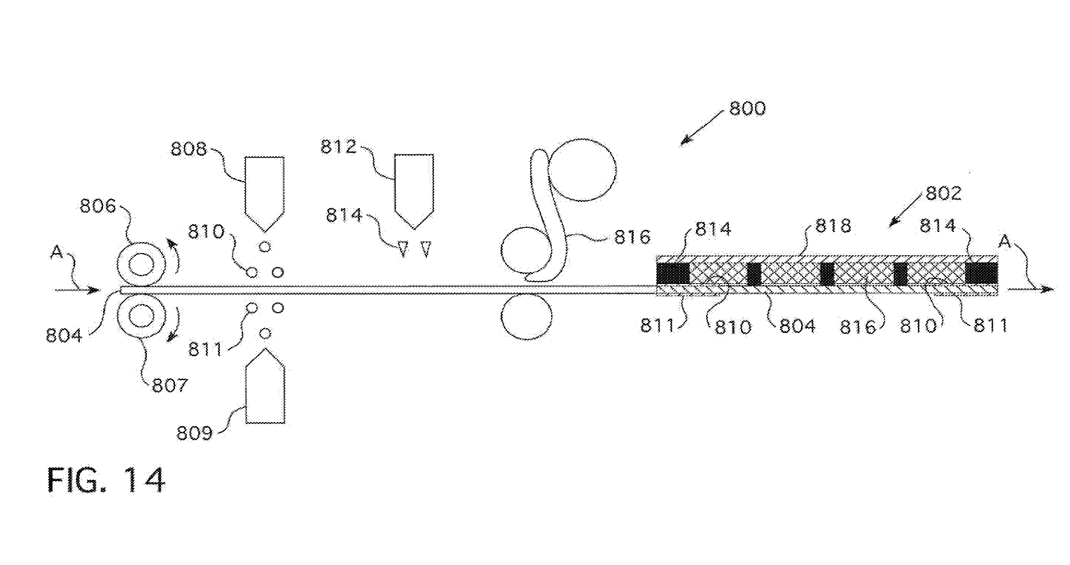

FIG. 14 illustrates one embodiment of a roll-to-roll process 800 for fabricating an actuator element 802 according to the present disclosure. The process 800 moves from left-to-right in the direction of arrow A. A dielectric elastomer film 804 is introduced into a first pair of rolls 806, 807 and is advanced to an electrode deposition station where electrode material 810, 811 is deposited on both sides of the dielectric elastomer film 804 by electrode deposition elements 808, 809 in a predetermined pattern. The dielectric film 804 can be used as-is or may be pre-strained (pre-stretched) in one dimension. Next, an adhesive 814 is applied (e.g., deposited) in a predetermined pattern by adhesive deposition element 812. An embossed compressive material 816 sheet (e.g., foam) is laminated onto the adhesive 814. Pressure is applied until compressive material 816 is attached to the adhesive 814. In one embodiment, the compressive material 816 may have already been laminated to a more rigid substrate 818. The final structure is an actuator element 802 comprising a dielectric film 804, electrodes 810, 811, adhesive 814, a compressive material 816, and a substrate 818 is provided.

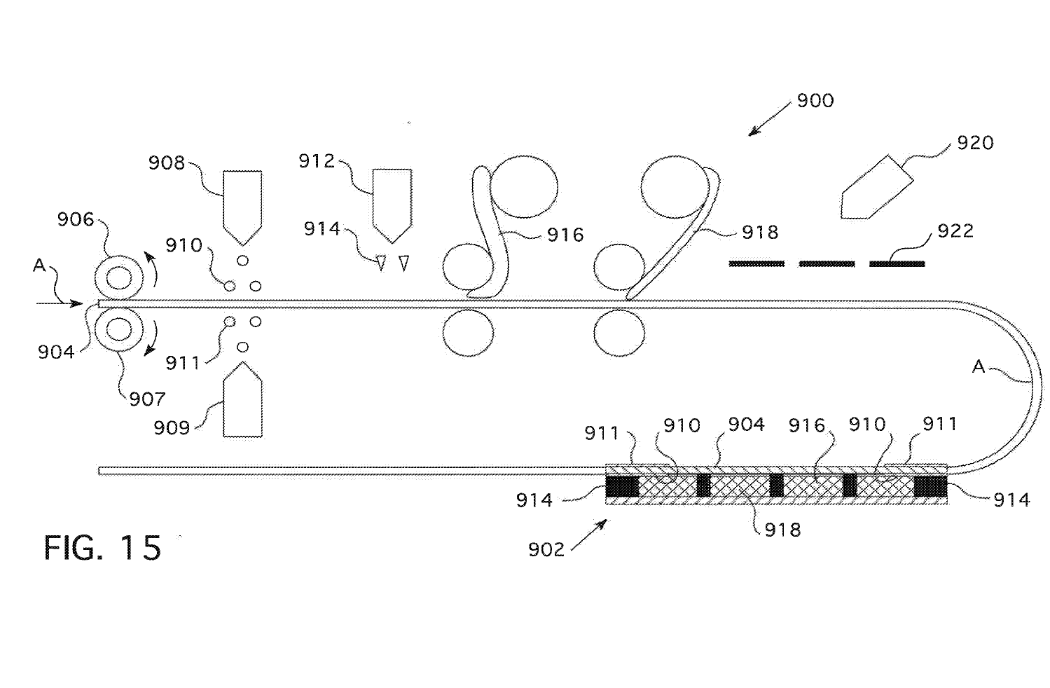

FIG. 15 illustrates one embodiment of a roll-to-roll process 900 for fabricating an actuator element 902 according to the present disclosure. The process 900 moves from left-to-right-to-left in the direction of arrow A. A dielectric elastomer film 904 is introduced into a first pair of rolls 906, 907 and is advanced to an electrode deposition station where electrode material 910, 911 is deposited on both sides of the dielectric elastomer film 904 by electrode deposition elements 908, 909 in a predetermined pattern. The dielectric film 904 can be used as-is or may be pre-strained (pre-stretched) in one dimension. Next, an adhesive 914 is applied (e.g., deposited) in a predetermined pattern by adhesive deposition element 912. A compressive material 916 sheet (e.g., foam) is laminated onto the adhesive 914. The compressive material 916 sheet optionally may be embossed before, at, or after this step. Next, a substrate 918 is laminated onto the compressive material 916. Optionally, the substrate 918 can be laminated onto the compressive material 916 prior to the compressive material 916 lamination step. Next either heat or photo exposure (e.g., IR or UV radiation) is applied in accordance with the description of FIGS. 7-12. Optionally, a patterned mask or platen 922 may be employed to localize the exposure to the heat and/or photo exposure. The final structure is an actuator element 902 comprising a dielectric film 904, electrodes 910, 911, adhesive 914, a compressive material 916, and a substrate 918 is provided.

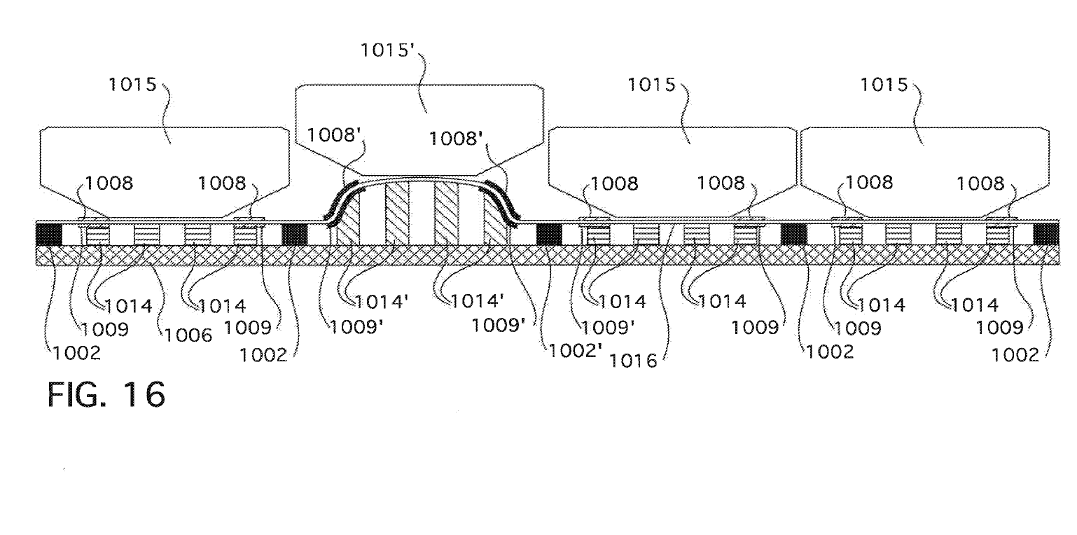

FIG. 16 illustrates one embodiment of an actuator element that additionally comprises key caps 1015 and 1015′ to provide a robust user interface. The actuator element comprises a surface 1006 laminated to a dielectric film 1016, separated by compressed compressive materials 1014 and 1014′, and adhered with adhesive 1002. On the surfaces of dielectric film 1016, there are electrodes 1008 and 1008′ opposing electrodes 1009, and 1009′. In active regions where electrodes 1008′ and 1009′ are powered, compressive materials 1014′ are expanded. Key caps 1015 and 1015′ can be attached to the dielectric film. In passive regions where electrodes 1008 and 1009 are not powered, adjacent keycaps are level with one another to provide a user surface that is substantially planar. In active regions where compressive materials 1014′ are expanded, key caps 1015′ are raised above the level of key caps in unpowered regions 1015. Adjacent key caps in active regions may be level with one another to provide raised regions which are larger and/or custom shaped. In some embodiments, key caps may be smaller at the base to minimize the restriction of the expansion of the dielectric film 1016 by the attachment of the key cap to the film. The upper edges of the key caps may be beveled or slightly rounded. The sides of the key caps may be straight to minimize rocking of the key caps. In another embodiment, the key caps may be suspended by a frame which is attached to the actuator element, similar to standard keyboard constructions, and are raised by the motion of the active regions of the actuator element.

Having described various embodiments of methods for fabricating actuator elements, it will be appreciated that a variety of techniques and materials may be employed to fabricate such structures.

In various embodiments described herein, the compressive materials may comprise foam or gel or molded or cast plastic or rubber . . . . The foams may be open cell or closed cell. The gels may be materials such as viscoelastic gels, soft elastomer gels, thermoplastic elastomer gels and the like. Materials may be thermoset or thermoplastic and include polyurethanes, silicones, olefinic polymers and copolymers, polyesters, acrylates, methacrylates, styrenic polymers and copolymers, vinyl polymers, thermoplastic elastomers, polyamides, and combinations of these materials.

In various embodiments described herein, the dielectric elastomer film may comprise silicone elastomers, acrylic elastomers, polyurethanes, thermoplastic elastomers, copolymers comprising polyvinylidene difluoride, pressure-sensitive adhesives, fluoroelastomers, polymers comprising silicone and acrylic moieties, and the like. The polymer matrix of the dielectric elastomer film may be a homopolymer or copolymer, cross-linked or uncross-linked, linear or branched, etc. As will be apparent to those skilled in the art, combinations of some of these materials may be used as the polymer matrix in methods of this invention. Copolymers and blends fall within the class of suitable polymers.

In various embodiments described herein, the electrode materials may comprise carbon or metal filled formulations, metal which may be textured or patterned, conductive polymers, and combinations.

In various embodiments described herein, the substrate may comprise polyurethanes, silicones, olefinic polymers and copolymers, polyesters, acrylates, methacrylates, styrenic polymers and copolymers, vinyl polymers, thermoplastic elastomers, polyamides, and combinations of these materials, engineering plastics, combinations of these materials, glass, or metal.

In various embodiments described herein, the adhesive may comprise any one of the following polyurethanes, silicones, olefinic polymers and copolymers, polyesters, acrylates, methacrylates, styrenic polymers and copolymers, vinyl polymers, thermoplastic elastomers, polyamides, and combinations of these materials.

In various embodiments either very stiff or very strongly adhering adhesives may be employed for an adhesive to support a pre-strained film while being adhered to rigid substrates, such as those of devices, for example. In one embodiment, either the modulus of adhesive or adhesion strength may be greater than the compressive force of a pre-strained film which may be employed in frameless actuator devices. For multilayer frameless actuator devices, the film-to-film adhesive is of lesser concern because the same adhesive, which is either stiff or of strong adhesion, can be used as a film-to-film adhesive. Adhesives are not limited to pressure sensitive and expandable adhesives but can be chosen from a wide range of materials including hot melt adhesives, b-stageable adhesives, and UV curable adhesives. Rigid or high modulus versions of the latter materials may offer the advantage of non-sticky surfaces which do not require the use of release liners.

Broad categories of previously discussed devices comprising actuator elements fabricated in accordance with the embodiments of the present techniques include, for example, personal communication devices, handheld devices, and mobile telephones. In various aspects, a device may refer to a handheld portable device, computer, mobile telephone, smartphone, tablet personal computer (PC), laptop computer, and the like, or any combination thereof. Examples of smartphones include any high-end mobile phone built on a mobile computing platform, with more advanced computing ability and connectivity than a contemporary feature phone. Some smartphones mainly combine the functions of a personal digital assistant (PDA) and a mobile phone or camera phone. Other, more advanced, smartphones also serve to combine the functions of portable media players, low-end compact digital cameras, pocket video cameras, and global positioning system (GPS) navigation units. Modern smartphones typically also include high-resolution touch screens (e.g., touch surfaces), web browsers that can access and properly display standard web pages rather than just mobile-optimized sites, and high-speed data access via Wi-Fi and mobile broadband. Some common mobile operating systems (OS) used by modern smartphones include Apple's IOS, Google's ANDROID, Microsoft's WINDOWS MOBILE and WINDOWS PHONE, Nokia's Symbian, RIM's BlackBerry OS, and embedded Linux distributions such as MAEMO and MEEGO. Such operating systems can be installed on many different phone models, and typically each device can receive multiple OS software updates over its lifetime. A device also may include, for example, gaming cases for devices (IOS, ANDROID, WINDOWS PHONES, 3DS), gaming controllers or gaming consoles such as an XBOX console and PC controller, gaming cases for tablet computers (IPAD, GALAXY, XOOM), integrated portable/mobile gaming devices, haptic keyboard and mouse buttons, controlled resistance/force, morphing surfaces, morphing structures/shapes, among others.

It is to be appreciated that the embodiments described herein illustrate example implementations, and that the functional elements, logical blocks, program modules, and circuits elements may be implemented in various other ways which are consistent with the described embodiments. Furthermore, the operations performed by such functional elements, logical blocks, program modules, and circuits elements may be combined and/or separated for a given implementation and may be performed by a greater number or fewer number of components or program modules. As will be apparent to those of skill in the art upon reading the present disclosure, each of the individual embodiments described and illustrated herein has discrete components and features which may be readily separated from or combined with the features of any of the other several embodiments without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is included in at least one embodiment. The appearances of the phrase “in one embodiment” or “in one aspect” in the specification are not necessarily all referring to the same embodiment.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, embodiments, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary embodiments and embodiments shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the invention and does not pose a limitation on the scope of the invention otherwise claimed. No language in the specification should be construed as indicating any non-claimed element essential to the practice of the invention. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments and appended claims.

1-16. (canceled)

17. A process of fabricating an actuator element, the method comprising:
providing a dielectric elastomer film, the dielectric elastomer film having first and second sides;
applying an electrode material on at least a portion of the first and the second side of the dielectric elastomer film; and
applying a compressive material to the first side of the dielectric elastomer film.

18. The process according to claim 17, further comprising applying a substrate to the compressive material.

19. The process according to claim 17, further comprising applying an adhesive to at least a portion of the first side of the dielectric elastomer film.

20. The process according to claim 17, wherein the compressive material is initially in an expanded state, the method further comprising compressing at least a portion of the compressive material.

21. The process according claim 17, wherein the compressive material is initially in a compressed state, the method further comprising expanding at least a portion of the compressive material.

22. The process according to claim 20, further comprising exposing at least a portion of the compressive material to heat.

23. The process according to claim 22, wherein the heat source is an infrared radiation heat source.

24. The process according to claim 20, further comprising exposing at least a portion of the compressive material to light.

25. The process according to claim 24, wherein the light source is an ultraviolet light source.

26. The process according to claim 17, further comprising stretching the dielectric elastomer film in one dimension.

27. The process according to claim 17, further comprising embossing the compressive material.

28. The process according to claim 17, further comprising applying a substrate to the compressive material.

29. The process according to claim 17, further comprising combining a key cap with the actuator element.

30. The process according to claim 17, wherein the step of applying an electrode material comprises depositing an electrode pattern.

31. The process according to claim 19, wherein the step of applying an adhesive comprises depositing an adhesive pattern.

32. The process according to claim 17, wherein the step of applying a compressive material comprises laminating.
